(19) United States
(12) Patent Application Publication
(10) Pub. No.: US 2008/0066805 A1
(43) Pub. Date: Mar. 20, 2008

(54) PRESSURE TANK SYSTEM WITH HEAT CONDUCTING LAYER

(75) Inventors: Franz Winter, Mainz (DE); Sandra Schaaf, Hochheim (DE); Andre Mack-Gardner, Aabergen (DE); Josef Kallo, Stuttgarat (DE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/533,537

(22) Filed: Sep. 20, 2006

(51) Int. Cl. F16K 17/40

(52) U.S. Cl. 137/68.12

(57) ABSTRACT

A pressure tank system including a pressure release valve that releases pressure in the tank if the valve exceeds a predetermined temperature. In order for the pressure release valve to be effective, it must detect heat at all areas of the tank system. The tank system includes a heat conducting device for transferring heat from anywhere on the tank system to the pressure release valve. In one embodiment, the heat conducting device is a heat conducting mesh that is wrapped around and outside of the pressure tank. In another embodiment, the heat conducting device is an aluminum sheet wrapped around the tank. In another embodiment, the heat conducting device includes heat conducting strips that extend along the tank and are connected to the pressure release valve.

### BACKGROUND OF THE INVENTION

1. Field of the Invention

This invention relates generally to a pressure tank system and, more particularly, to a pressure tank system for storing hydrogen, where the pressure tank system includes a heat conducting device for transferring heat to a pressure release valve.

2. Discussion of the Related Art

Hydrogen is a very attractive fuel because it is clean and can be used to efficiently produce electricity in a fuel cell. The automotive industry expends significant resources in the development of hydrogen fuel cell systems as a source of power for vehicles. Such vehicles would be more efficient and generate fewer emissions than today's vehicles employing internal combustion engines.

Typically hydrogen gas is stored in a compressed gas tank under high pressure on the vehicle to provide the hydrogen gas necessary for the fuel cell system. The pressure in the compressed tank can be upwards of 700 bar. In one known tank design, the compressed tank includes an inner plastic liner that provides a gas tight seal for the hydrogen gas, and an outer carbon fiber composite layer that provides the structural integrity of the tank. Because hydrogen gas is a very light and diffusive gas, the inner liner and the tank connector components must be carefully engineered in order to prevent leaks. The hydrogen gas is removed from the tank through a pipe. At least one pressure regulator is typically provided that reduces the pressure of the hydrogen gas within the tank to a pressure suitable for the fuel cell system.

The structural integrity of the pressure tank may be compromised as a result of high internal pressure if the outer wall of the tank is exposed to fire or high heat for an extended period of time. Also, the heat itself may damage the tank. Rupture of or damage to the tank may lead to the escape of the gas therein. A pressure release valve is typically provided in combination with the tank so that if the pressure in the tank increases to an undesirable level, the valve opens to slowly and controllably depressurize the tank. In one design, the pressure release valve includes a meltable trigger mechanism. When the trigger mechanism is exposed to heat above a certain temperature threshold, the trigger mechanism will melt and open the valve, allowing the release of pressure within the tank. In one embodiment, the melting temperature of the trigger mechanism is about 108° C.

In order for the pressure release valve to function properly, the temperature in the immediate area of the valve must reach the temperature threshold to open the release valve. Particularly, if the temperature of the tank increases above the threshold some distance away from the pressure release valve, for example at an opposite end of the tank, the tank may be subjected to extreme heat for an extended period of time before the temperature at the pressure release valve is sufficiently high enough to cause the release valve to open, possibly allowing the tank to rupture. This problem may be enhanced because the outer material of the tank may be a composite, which has a low heat conduction property.

### SUMMARY OF THE INVENTION

In accordance with the teachings of the present invention, a pressure tank system is disclosed that includes a pressure release valve that releases pressure in the tank if the valve exceeds a predetermined temperature. In order for the pressure release valve to be effective, it must detect heat at all areas of the tank system. Because the tank may be a low conductor of heat, the present invention proposes providing a heat conducting device for transferring heat from anywhere on the tank system to the pressure release valve.

In one embodiment, the heat conducting device is a heat conducting mesh that is wrapped around an outside of the pressure tank. In another embodiment, the heat conducting device is an aluminum sheet wrapped around the tank. In another embodiment, the heat conducting device includes heat conducting strips that extend along the tank and are thermally connected to the pressure release valve.

Additional features of the present invention will become apparent from the following description and appended claims, taken in conjunction with the accompanying drawings.

### BRIEF DESCRIPTION OF THE DRAWINGS

FIG. 1 is a length-wise view of a pressure tank system including a heat conducting mesh wrapped around the tank, according to an embodiment of the present invention;

FIG. 2 is a length-wise cross-sectional view of a pressure tank system including an outer heat conducting layer, according to another embodiment of the present invention; and

FIG. 3 is a length-wise view of a pressure tank system including heat conducting strips positioned along the pressure tank, according to another embodiment of the present invention.

### DETAILED DESCRIPTION OF THE EMBODIMENTS

The following discussion of the embodiments of the invention directed to a pressure tank system including a heat conducting device is merely exemplary in nature, and is in no way intended to limit the invention or its applications or uses.

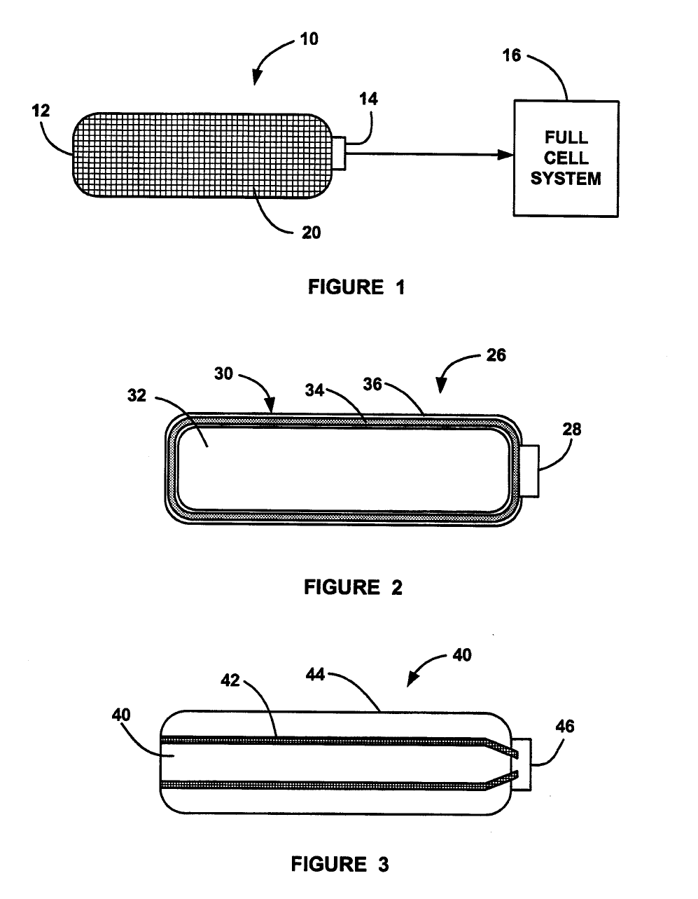

FIG. 1 is a length-wise view of a pressure tank system 10 including a pressure tank 12 and a pressure release valve 14, according to one embodiment of the present invention. In one non-limiting embodiment, the pressure tank system 10 stores compressed hydrogen gas and has particular application for providing hydrogen fuel to a fuel cell system 16. The tank 12 can be any suitable tank for this purpose, such as a tank including an inner plastic gas-tight liner and an outer composite layer that provides structural integrity. Those skilled in the art will readily recognize that the tank system of the invention can have many different configurations within the scope of the present invention. The pressure release valve 14 can be any pressure release valve suitable for the purpose discussed herein, such as a pressure release valve that includes a meltable trigger mechanism of the type discussed above.

As discussed above, the material of the tank 12 may be a poor conductor of heat. Therefore, if the tank system 10 is exposed to fire or high heat at a location far enough away from the pressure release valve 14 that causes the pressure in the tank 12 to increase, the pressure release valve 14 may not open before the pressure tank 12 is compromised. According to this embodiment of the invention, a heat conducting mesh layer 20 is wrapped around the outer surface of the pressure tank 12 so that the mesh layer 20 contacts all portions of the outer surface of the pressure tank 12, and is in thermal contact with the pressure release valve 14. The heat conducting mesh layer 20 is made of a high heat conducting material, such as steel, copper, aluminum, etc. The diameter of the wires in the mesh layer 20 and the hole size of the mesh layer 20 can be any one suitable for the purposes described herein. Therefore, if any portion of the tank system 10 is exposed to high heat or fire, that heat is quickly transferred to the pressure release valve 14 by the heat conducting mesh layer 20, so that the pressure relief valve 14 can reliably regulate the pressure within the tank 12 as was intended. The mesh layer 20 can be attached to the tank 12 in any suitable manner.

FIG. 2 is a length-wise cross-sectional view of a tank system 26 also including a pressure tank 30 and a pressure release valve 28, according to another embodiment of the present invention. The pressure tank 30 includes any inner gas tight liner 32, typically plastic, and an outer carbon fiber composite layer 34 that provides structural integrity. In this embodiment, a heat conducting sheet, foil or layer 36 is wrapped all around an outside of the composite layer 34 for the same purpose as the heat conducting mesh layer 20. The thickness of the layer 34 can be any suitable thickness for the purposes described herein. Therefore, if any area of the pressure tank system 26 is exposed to high heat or fire that heat is quickly transferred to the pressure relief valve 28. Further, the layer 36 acts as a heat shield to reject heat from the tank 30. In one embodiment, the heat conducting material of the layer 34 is aluminum, although other materials may be equally applicable. Also, the heat conducting layer 36 can be attached to the composite layer 34 by any suitable technique.

FIG. 3 is a length-wise view of a tank system 40, according to another embodiment of the present invention. In this embodiment, heat conducting strips 42 are positioned in contact with a pressure tank 44 and in thermal contact with a pressure release valve 46. The heat conducting strips 42 are used for the same purpose as discussed above to transfer heat from any location in the tank system 40 to the pressure relief valve 46. The number of the strips 42, the thickness of the strips 42 and the width of the strips 42 can be designed for a particular tank system to be the most effective as possible. Also, the strips 42 can be aluminum strips, however, any suitable heat conducting material can be used. Further, the strips 42 can be adhered to the pressure tank 44 by any technique, such a gluing or paste.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A pressure tank system comprising:
a tank for storing a gas under pressure;
a pressure release valve coupled to the tank and being operable to control the pressure within the tank by releasing gas therein if the pressure within the tank exceeds a predetermined pressure; and
a heat conducting device positioned in thermal contact with the pressure release valve, said heat conducting device transferring heat from surfaces of the tank remote from the pressure relief valve to the pressure relief valve.

2. The tank system according to claim 1 wherein the heat conducting device is a heat conducting mesh wrapped around an outside surface of the tank.

3. The tank system according to claim 2 wherein the heat conducting mesh is made of a heat conducting material selected from the group consisting of steel, copper and aluminum.

4. The tank system according to claim 1 wherein the heat conducting device is a heat conducting layer completely encapsulating the tank.

5. The tank system according to claim 4 wherein the heat conducting layer is an aluminum layer.

6. The tank system according to claim 1 wherein the heat conducting device is a plurality of heat conducting strips attached to an outer surface of the tank and being spaced apart from each other.

7. The tank system according to claim 6 wherein the heat conducting strips are aluminum strips.

8. The tank system according to claim 1 wherein the tank includes an inner liner layer and an outer composite layer.

9. The tank system according to claim 1 wherein the tank contains a hydrogen gas.

10. The tank system according to claim 9 wherein the hydrogen gas is provided to a fuel cell system.

11. A tank for storing a gas, said tank comprising:
a pressure relief valve being operable to control the pressure within the tank; and
a heat conducting device positioned in thermal contact with the pressure release valve, said heat conducting device transferring heat at remote locations from the pressure relief valve to the pressure relief valve.

12. The tank according to claim 11 wherein the heat conducting device is a heat conducting mesh wrapped around an outside surface of the tank.

13. The tank according to claim 11 wherein the heat conducting device is an aluminum layer completely encapsulating the tank.

14. The tank according to claim 11 wherein the heat conducting device is a plurality of heat conducting strips attached to an outer surface of the tank and being spaced apart from each other.

15. A pressure tank system for storing hydrogen gas for a fuel cell system, said tank system comprising:
a tank for storing the gas under pressure;
a pressure release valve coupled to the tank and being operable to control the pressure within the tank by releasing the gas therein if the pressure within the tank exceeds a predetermined pressure; and
a heat conducting device positioned in contact with an outer surface of the pressure tank and being in thermal contact with the pressure release valve, said heat conducting device transferring heat from surfaces of the tank remote from the pressure relief valve to the pressure relief valve.

16. The tank system according to claim 15 wherein the heat conducting device is a heat conducting mesh wrapped around an outside surface of the tank.

17. The tank system according to claim 15 wherein the heat conducting device is a heat conducting layer completely encapsulating the tank.

18. The tank system according to claim 17 wherein the heat conducting layer is an aluminum layer.

19. The tank system according to claim 15 wherein the heat conducting device is a plurality of heat conducting strips attached to an outer surface of the tank and being spaced apart from each other.

20. The tank system according to claim 15 wherein the tank includes an inner liner layer and an outer composite layer.
